(19) United States
(12) Patent Application Publication
(10) Pub. No.: US 2008/0212773 A1
(43) Pub. Date: Sep. 4, 2008

(54) Parallel data stream decryption device

(76) Inventor: Christian L. Houlberg, Ventura, CA (US)

Correspondence Address: NAVAIRWD COUNSEL GROUP, 575 "I" AVE, SUITE 1 (CODE K00000E), BUILDING 36, ROOM 2308, POINT MUGU, CA, 93042-5049, US

(21) Appl. No.: 11/713,823

(22) Filed: Mar. 2, 2007

(51) Int. Cl. H04N 7/167

(52) U.S. Cl. 380/200

(57) ABSTRACT

A parallel data stream decryption device which allows a user to decrypt radar video data obtained from a missile seeker which was encrypted while in a parallel data format. The decryption device has a computer program which decryptes the radar video data contained in an encrypted data file and creates a decrypted binary data file. The computer software then extracts data from the decrypted binary data file and converts the extracted data to an ASCII text file.

### BACKGROUND OF THE INVENTION

1. Field of the Invention

The present invention relates generally to devices for decrypting data. More particularly, the present invention relates to computer software which allows a user to decrypt radar video data obtained from a missile seeker which was encrypted while in a parallel data format.

2. Description of the Prior Art

There is a need to decrypt video data that was encrypted using a parallel encryption unit and save the decrypted data in a form that can be easily analyzed. The video data is first recorded in a file format containing unencrypted recorder timing headers interleaved with the encrypted data. This file is transferred to a Personal Computer (PC) which is connected to a Parallel Data Decryption Unit.

The problem is to provide the user with the ability to manipulate the video data in this file and put the video data in a form that can be conveniently decrypted and easily analyzed. The user must first be able to select the range of video data to decrypt, next send the video data to the Parallel Data Decryption Unit, and then receive the decrypted video data from the Parallel Data Decryption Unit. The user must save the decrypted video data to a file and also byte align the decrypted video data and save it to another file for analysis. The user must also be provided the ability to view the range of scans over which the resulting decrypted video data encompasses and select all or part of this range of decrypted video data to convert to a text form. This text form, if indicated, must be compatible with Microsoft Excel, which is a spreadsheet program.

### SUMMARY OF THE INVENTION

The parallel data stream decryption device comprising the present invention overcomes some of the disadvantages of the past including those mentioned above in that it comprises a highly efficient and effective hardware and computer software program for converting raw radar video data to an ASCII text file for use in a Windows Excel environment.

The computer program at the user direction opens an encrypted file by using a drop down menu bar to select the encrypted file to be decrypted. The file to be decrypted may either be a recorder file containing timing headers and encrypted data or a filtered file containing only encrypted data. When the file selected by the user for decryption is a recorder file, the file is scanned and the file size, data block size and file time range are displayed on a computer monitor. All or part of the radar video data is decrypted after the user enters a time range for the radar video data the user wants decrypted.

When the file does not contain recorder timing headers only file size is displayed on the monitor and the user selects a decrypt button to decrypt the entire encrytped file.

The computer program implements a decryption process by transferring encrypted radar video data from the file to a parallel decryption unit and receiving decrypted data from the parallel decryption unit. The program then byte aligns the decrypted data resulting in a decrypted byte aligned data file. The decrypted data in the file is written in a binary format.

The user extracts and converts the binary data in the file to an ASCII file by clicking on an Extract button. The user also has the ability to change the frame and scan counts to a narrower range of decrypted binary data which reduces the amount of radar video data to be extracted and the size of the resulting ASCII file.

When the amount of data to be extracted exceeds the maximum amount of data that Excel allows for import into a single Excel worksheet, the user is ask if the extraction must be compatible with Excel. If the user answers “Yes” the program separates the extracted data into multiple files, all of which have a byte size which is compatible for input into a single Excel worksheet.

### BRIEF DESCRIPTION OF THE DRAWINGS

FIG. 1 is a block diagram illustrating the electrical components for the parallel data stream decryption device comprising the present invention;

FIG. 2 is a flow chart for the DataDecryption.exe computer software program utilized by the parallel data stream decryption device constituting the present invention;

FIG. 3 illustrates the information which appears on a monitor when a user elects to open an encrypted radar video data file containing recorder timing headers;

FIG. 4 illustrates the information which appears on a monitor following the decryption of the designated encrypted data in the encrypted data file;

FIG. 5 is a flow chart for the File routine of the DataDecryption.exe computer software program;

FIG. 6 is a flow chart for the On Decrypt Button routine of the DataDecryption.exe computer software program;

FIG. 7 is a flow chart for the Decrypt Indicated Data routine of the DataDecryption.exe computer software program;

FIG. 8 is a flow chart for the Decrypt Data routine of the DataDecryption.exe computer software program;

FIG. 9 is a flow chart for the Byte Align Data routine of the DataDecryption.exe computer software program;

FIG. 10 is a flow chart for the On Extract Button routine of the DataDecryption.exe computer software program;

FIG. 11 is a flow chart for the Validate Extract Range routine of the DataDecryption.exe computer software program; and

FIG. 12 is a flow chart for the Extract Data routine of the DataDecryption.exe computer software program;

### DETAILED DESCRIPTION OF A PREFERRED EMBODIMENT

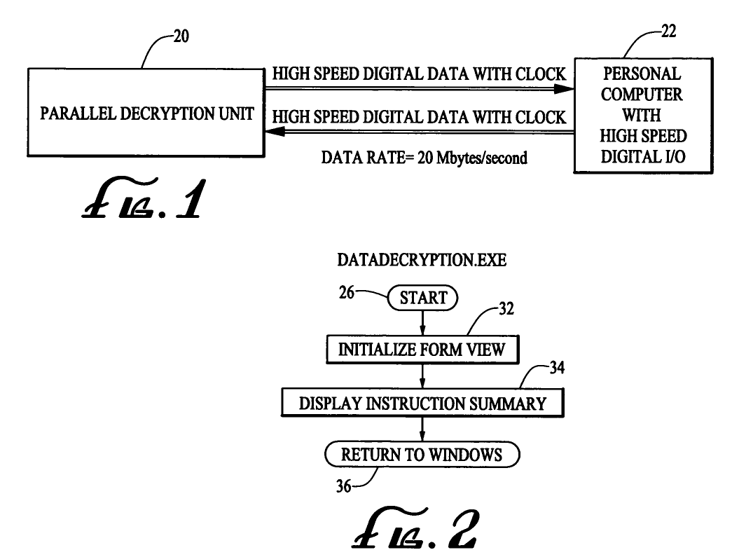

Referring to FIGS. 1, 2, 3 and 4, the present invention addresses all the problems listed above and is an integral component of a complete turn-key system used to capture and analyze radar video data provided by an Anti-Ship Cruise Missile (ASCM) Seeker. The present invention comprises a computer software application, a Data Decryption device 20 and a high speed interface board operating within a Personal Computer (PC) 22. Personal computer 22 sends the encrypted radar video data to the Data Decryption Unit 20 and saves the resulting decrypted radar video data to a file within personal computer 22.

A data encryption unit receives unencrypted radar video data in a synchronous parallel form from the ASCM's Radar Video Telemeter and outputs encrypted radar video data in a synchronous parallel form to a recorder. In addition, when recorded on the recorder, the encrypted radar video data is interleaved with unencrypted recorder timing headers.

The high speed interface board included in personal computer 22 is a National Instruments Model NI PCI-6534 Interface Board, which is commercially available from National Instruments Corporation of Austin, Tex. The PCI-6534 is a high speed 32 bit parallel digital I/O interface which operates at speeds up to 80 megabytes per second.

When the user initiates the software “DataDecryption.exe” (program step 26), the computer monitor 24 provides the following information:
BQM-34SH Recorded Data Decryption Program
1] Open an Encrypted Data File.
2] Specify a Header Block Range over which to Decrypt the Data.
3] Envoke the Decrypt Function.
4] Additionally, Specify a Range of Scans over which to Convert the Data to an ASCII Comma Delimited Form (for Excel Import).
5] Envoke the Extract Function. or
1] Open a Decrypted Data File.
2] Specify a Frame and Scan Count Range over which to Convert the Data to an ASCII Comma Delimited Form (for Excel Import).
3] Envoke the Extract Function.

The information appearing on monitor 24 provides the user with a short set of steps needed to process recorded radar video data files encrypted with the Parallel Data Encryption Unit. The resulting processed files are in one of two unencrypted forms that can be conveniently analyzed The processed files are binary and text files.

The binary file consist of a 3-byte frame sync, a 2-byte frame count and a 1-byte scan count followed by up to 4,090 bytes of radar video data with an embedded detection gate for identifying the location of a target. The text file is approximately 7 times the size of the binary file and consist of the same data, with the exception of the frame sync, in a comma delimited text form. The following example illustrates a text file.

```
Frame, <frame count>
Scan,<scan count>
Video,Gate
<video sample>,<gate sample>
<video sample>,<gate sample>
  . . . . .
<video sample>,<gate sample>
  . . . . .
Frame,<frame count>
  . . . . .
```

To decrypt a file the user opens an encrypted file, with or without recorder timing headers, by selecting from a menu bar appearing on monitor 24 the following sequence: File, Open, and Encrypted File. A file open dialog will appear on monitor 24 from which the user selects either a recorder file containing timing headers (*.red) or a filtered file containing only encrypted data (*.fed). When the user elects to open one of the encrypted data files containing recorder timing headers, the encrypted files will be listed on monitor 24 as shown in the following example:

| | |
|---|---|
| TestFile1.red | TestFile3.red |
| TestFile2.red | TestFileX.red |
| Testfile22.red | |

The user can then select a file to open, such as, “TextFile1.red”.

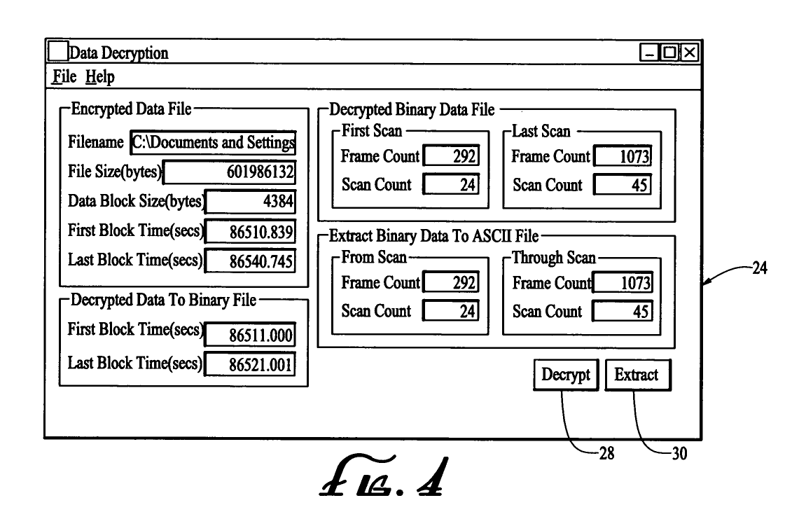

If the file which the user selects to open contains recorder timing headers the file will be scanned and the file size, data block size and time range are displayed in the manner shown in FIG. 3. For the encrypted file shown in FIG. 3, the file size in bytes is 601986132, the data block size in bytes is 4384, the First Block time in seconds is 86510.839 and the last block time is 86540.745.

The radar video data is decrypted after the user enters the time range of the data to be decrypted in the First Block Time and Last Block Time text boxes and clicks on the Decrypt button 28 shown in FIG. 3.

If the file contains no recorder timing headers, i.e. is a “.fed” file, only the file size is displayed on monitor 24 and the user only needs to click on the Decrypt button 28 to decrypt the entire encrypted file.

When the file has been decrypted and byte aligned (*.add) all or part of the decrypted byte aligned file can be extracted and converted to a comma delimited text form (*.txt).

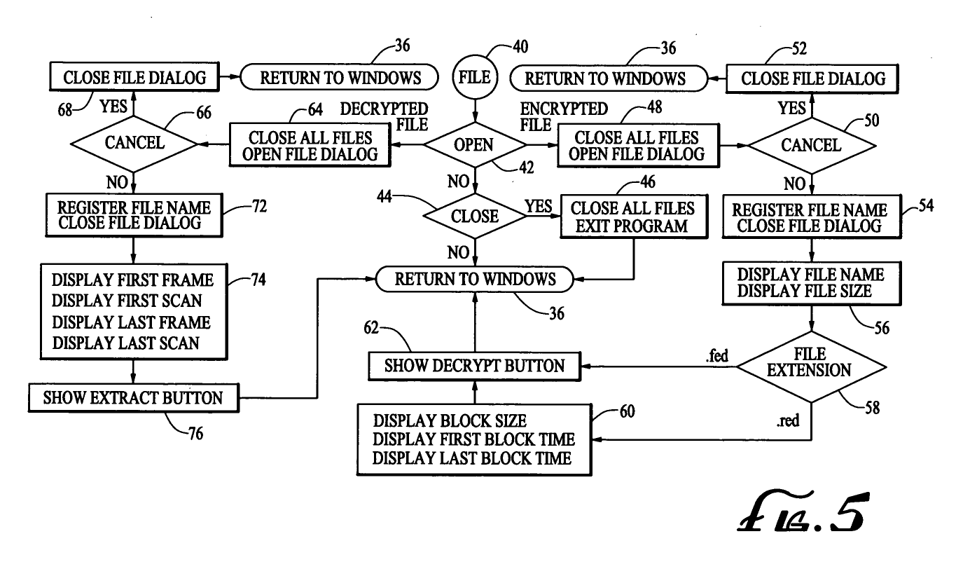

As shown in FIG. 4, the frame and scan counts of the first and last scans are displayed on monitor 24 in the “Decrypted Binary Data File” text boxes and the “Extract Binary Data to ASCII File” text boxes. In this example, the first frame count displayed is 292, the first scan count displayed is 24, the last frame count displayed is 1073 and the last scan count displayed is 45.

The user has the ability to change frame and scan counts in the “Extract Binary Data to ASCII File” text boxes to a narrower range thereby reducing the amount of data extracted and the size of the resulting file. Once the desired range has been entered by the user in the “Extract Binary Data to ASCII File” text boxes, the user clicks on the Extract button 30 to extract and convert the decrypted radar video data to a text file.

If the amount of data extracted is larger than the maximum amount that can be imported into a Microsoft Excel worksheet, the user is asked if the extraction needs to be compatible with Microsoft Excel. If the answer is “Yes”, the extracted data is broken into multiple files all of which have a size compatible with importation into Microsoft Excel. Microsoft Excel is a spreadsheet program written and distributed by Microsoft for computers using the Microsoft Windows operating system. It features an intuitive interface and calculation and graphical tools. A spread sheet is a rectangular table or grid of information.

All or part of a file that has already been decrypted and byte aligned can at a later time be extracted and converted to a comma delimited text form for analysis by the user. To extract radar video data from a decrypted byte aligned file at a later time the user must select the file from the menu bar appearing on monitor 24 using the following sequence: File, Open, Decrypted File. A file open dialog will appear on monitor 24 from which the user selects a decrypted file. When the user elects to select one of the decryted and byte aligned files for data extraction, i.e. the file is a “.add” file, the file is listed on monitor 24 as shown by the following example:
TestFile1(86511-86521).add
TestFile1(86741-86751).add
   The selected file is then opened and scanned and the frame and scan counts of the first and last scans are displayed on monitor 24.

The following is an example of the files that would appear on monitor 24 when the user selects File, Open, Encrypted File and All Files(*.*) from the “Files of type:” dialog box.

| | |
|---|---|
| TestFile1(855_1-877_0).txt | TestFile1(951_1-983_0).txt |
| TestFile1(86511-86521).add | TestFile1(983_1-1015_0).txt |
| TestFile1(86511-86521).fed | TestFile1.red |
| TestFile1(86511-86521).rdd | TestFile2.red |
| TestFile1(887_1-919_0).txt | TestFile22.red |
| TestFile1(919_1-951_0).txt | TestFile3(86741-86751).add |

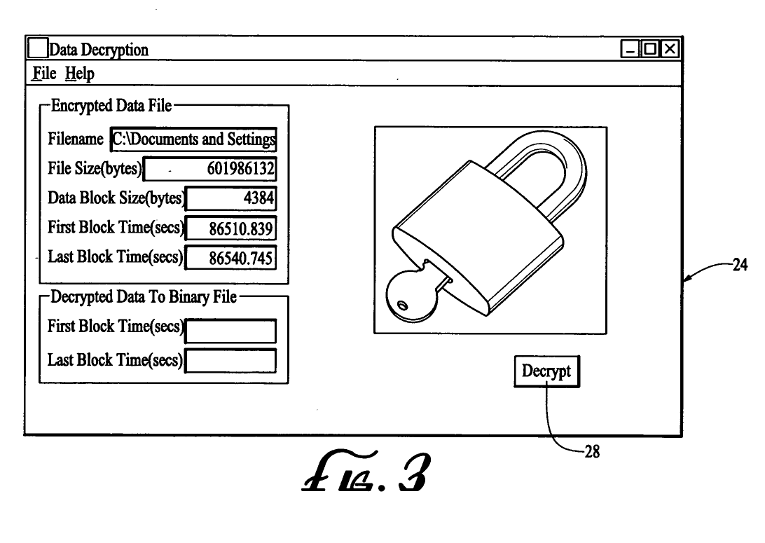

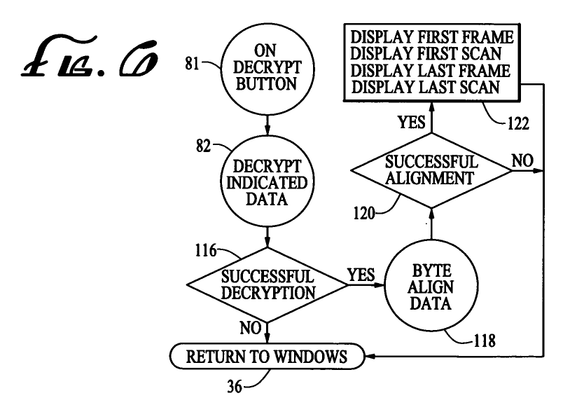

Referring to FIGS. 2 and 5, the user starts the computer software program (program step 26) by double clicking on the DataDecryption.exe file. Program steps 32 and 34 initialize the form view and display the BQM-34SH Recorded Data Decryption Program information on computer monitor 24. Program step 36 of the computer program returns the user to the Windows Operating System environment, which will be referred to as Windows.

When the user clicks on file (program step 40) a drop down menu appears on monitor 24. Program step 42 is a decision block which allows the user to open a file. Program step 44 is a decision block which allows the user to close all open files and exit the program. When the user clicks on close the software proceeds to program step 46 closing all open files and exiting the program. Program step 36 returns the user to Windows.

If the user clicks on anything else, i.e. does not open a file or close a file, the program returns to Windows.

When the user clicks on open (program step 42), the user can open an encrypted file or a decrypted file. Normally the user opens an encrypted file. Program step 48 insures that all open files are closed. A file dialog is then opened which allows the user to browse through the computer's directory to select a file which the user wants to decrypt. The file dialog is a standard Windows file dialog which shows by default a tree of folders containing encrypted files for decryption. The file dialog includes a pair of buttons, a cancel button and an open button. When the user clicks on the cancel button (program step 50), the file dialog is closed (program step 52) and the program returns to Windows (program step 36).

The user selects a particular file for decryption by double clicking on the file which opens the file. The user may also use the open button to open a file which the user wants to decrypt by single clicking on a file and clicking on the open button. The file name selected for decryption is registered with the program and the file dialog is closed (program step 54). Program step 56 displays the file name and the file size of the opened file to the user in the manner shown in FIG. 3.

Program step 58 is a decision block. The program decides which type of file has been selected, an “.red” file which is an encrypted file from the recorder or a filtered encrypted file which has an “fed” extension. When the file is a recorder's encrypted data file, program step 60 displays the data block size, the first block time and the first block time in the manner shown in FIG. 3. Program step 62 shows the decrypt button 28 on monitor 24.

When the file is a filtered encrypted data file, the software proceeds directly from program step 58 to program step 62. A “.fed” file has its recorder headers removed, therefore its block size and first and last time blocks are not displayed. For a “.fed” file only the file name and file size are displayed.

When the user wants to open a binary decrypted file, program step 64 closes all open files and opens a file dialog. Program step 66 is a decision block which allows the user to click on the cancel button. When the user clicks on the cancel button the software proceeds 68 closing the file dialog and the returns to Windows (program step 36).

When the user double clicks on a particular file to be opened or uses the open button to open a particular file, the program registers the file name and closes the file dialog (program step 70). Program step 72 displays the first frame, first scan, last frame and last scan information of the opened file as shown in FIG. 4. Program step 76 shows the Extract button 30.

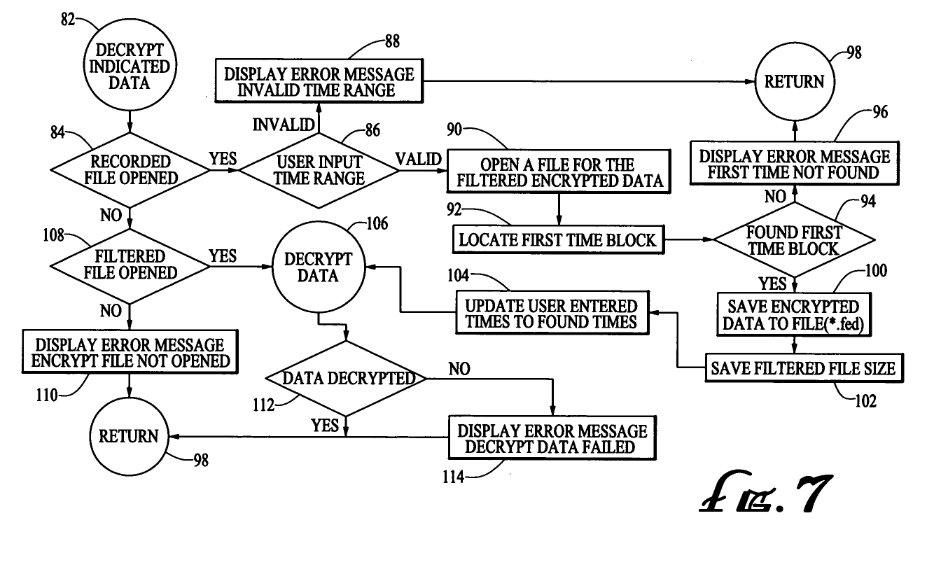

Referring to FIGS. 3, 6, 7, 8 and 9, when the user clicks on the decrypt button 28, the software proceeds to the Decrypt Indicated Data routine illustrated in FIG. 7. This routine decrypts data with “fed” and “red” extensions. Program step 84 is a decision block which determines if the file is a “.red” file. If the file is an “.red” file, the program looks at the user input time range to see if the time range input by the user is a valid time range (program step 86). If the time range input by the user is an invalid time range, an error message “Invalid Time Range” is displayed to the user (program step 88) and the software returns to the On Decrypt Button routine 81 of FIG. 6 (program step 98). If the time range input by the user is a valid time range, then the program opens a file to create a filtered encrypted data file which is a “.fed” file (program step 90). Program step 92 locates the first time block in the recorded encrypted data file, which is a “.red” file. If the first time block is not found, an error message “First Time Not Found” is displayed to the user (program step 96).

When the program finds the first time block, the encrypted data through the last time block is saved to the “.fed” file (program step 100). Program step 102 saves the filtered file size for display and program step 104 updates the user entered times to the actual times located by the software. The user can enter a time range within the time range covered by the file, but the time range entered by the user might not fall on time specified by a block of data. The program then adjusts the time range to insure that the time range entered by the user falls on the time indicated by the closest block of data.

When the file is not a recorded data file, the software proceeds to program step 108 to determine if a filtered encrypted data file was opened. If a filtered encrypted data file is open, the software proceeds directly to program step 106 which decrypts the data. If a filtered encrypted data file is not open, the software displays an error message “Encrypt File Not Open” (program step 110).

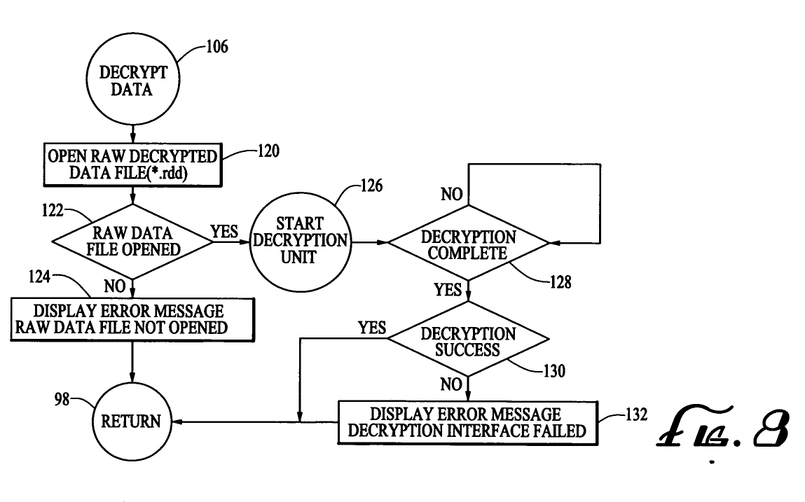

Program step 106 enters the Decrypt Data routine of FIG. 8. After the data is decrypted, the software returns to a decision block, data decrypted (program step 112) and determines if the data has been decrypted. When the answer is “Yes” the software returns to the On Decrypt Button routine of FIG. 6. When the answer is “No” program step 114 displays an error message “Decrypt Data Failed” and the software returns to the On Decrypt Button routine of FIG. 6.

Upon returning to the On Decrypt Button routine of FIG. 6, the software checks to if the decryption of the radar video data in the file being decrypted was successful (program step 116). If the decryption of the data was not successful, the software returns to Windows (program step 36).

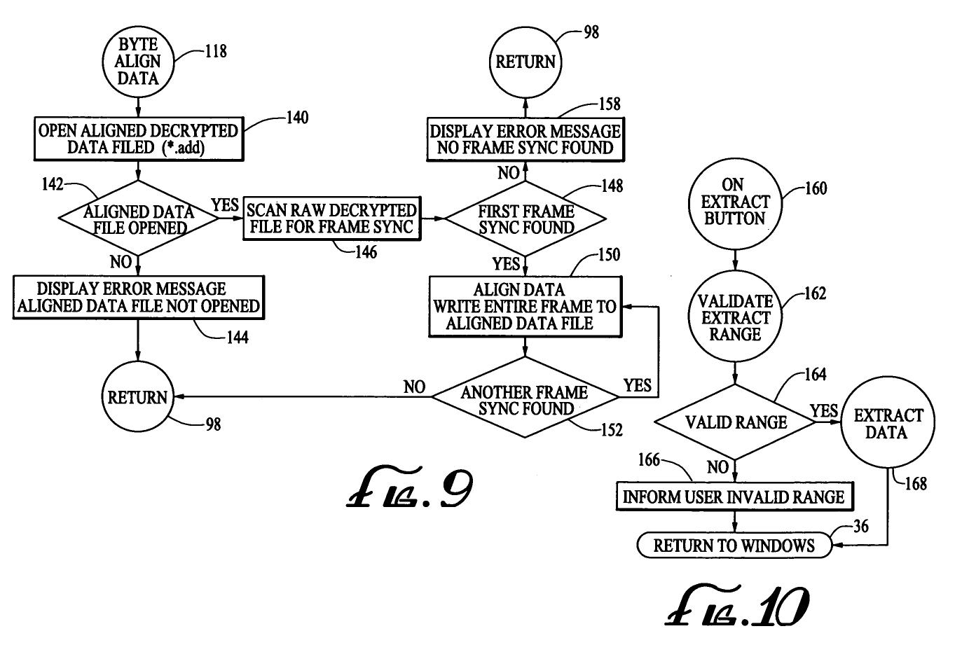

When the radar video data is successfully decrypted, the Byte Align Data routine of FIG. 9 is called. If the Byte Align Data routine is successful (program step 120), the software proceeds to program step 122. If the data alignment, was successful program step 122 displays the first frame, first scan, last frame and last scan charts on monitor 24. If the data alignment was not successful, the software returns to Windows (program step 36).

Referring to FIG. 8, the Decrypt Data routine creates and opens a raw decrypted data file, which is a “.rdd” file (program step 120). Program step 122 determines if the raw decrypted data file was successfully opened. If the answer is “No”, an error message “Raw Data File Not Opened” is displayed (program step 124). If the answer is “Yes”, the software starts Data Decryption Unit 20 (FIG. 1). When the decryption process is complete (program step 128), the software checks to determine if the decryption was successful (program step 130). If the answer is “Yes”, the software returns to the Decrypt Indicated Data routine of FIG. 7.

When the decryption is not successful, the software displays an error message “Decryption Interface Failed” (program step 132). The software then returns to the Decrypt Indicated Data routine of FIG. 7.

At this time it should be noted that the software runs two threads to decrypt the radar video data. The first thread outputs the radar video data to Data Decryption device 20 for decryption. The second thread reads the decrypted data from Data Decryption device 20 and then saves the data.

Referring to FIG. 9, the Byte Align Data routine 118 opens an aligned decrypted data file which is a “.add” file (program step 140). This file is a new file created by the Byte Align Data routine 118. Program step 142 checks to see if the aligned decrypted data file was successfully opened. If the answer is “No”, program step 144 displays an error message “Aligned Data File Not Opened” and the software returns to the On Decrypt Button routine of FIG. 6.

If the answer is “Yes” the software scans the raw decrypted data file for a frame sync (program step 146). The frame sync allows for alignment of the data by determining how many bits are to be shifted to align the data. Program step 148 is a decision block which determines if the first frame sync has been found. If the software does not find the frame sync, program step 158 displays an error message “No Frame Sync Found”. When a frame sync is found, the program aligns the data using the frame sync offset as a reference for the alignment and writes the entire frame to the aligned data file. Program steps 150 and 152 form a loop which allows the software to continue to align all of the frames in the block of data being decrypted.

The rational for looking for each frame sync in the block of data being decrypted is that there is a possibility that a bit can be dropped. This changes the number of bits offset in the block of data being decrypted.

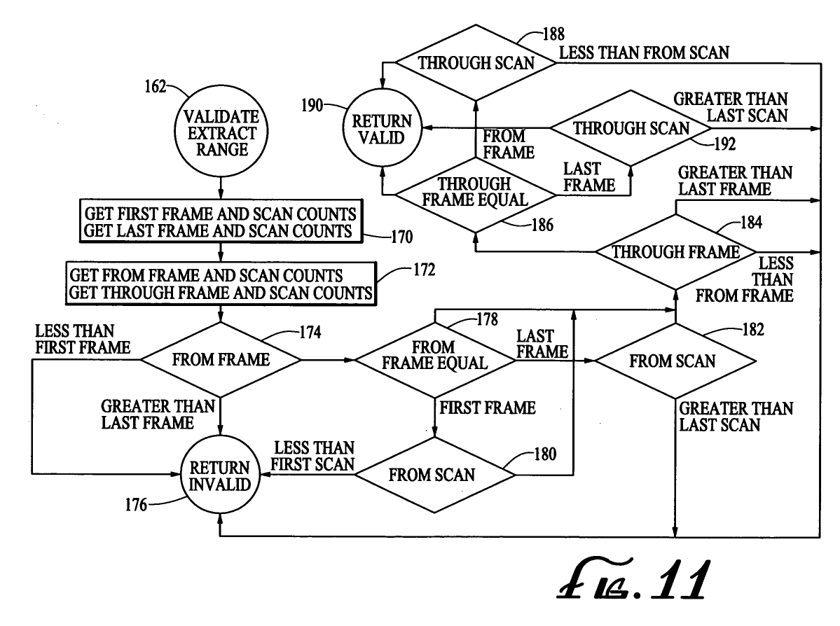

Referring to FIGS. 4 and 10, the user has the option to extract radar video data from the decrypted file and convert the data to ASCII text by clicking on the Extract button 30, which is shown in FIG. 4. Clicking on the Extract button 30 results in the software calling the On Extract Button routine of FIG. 10. Program step 162 enters the Validate Extract Range routine. Program step 164 is a decision block which determines if the range of data to be extracted to ASCII text is a valid range. If the answer is “No”, the software informs the user that the range is invalid (program step 166) and the software returns to Windows (program step 36). If the answer is “Yes”, the software proceeds to the Extract Data Routine of FIG. 12.

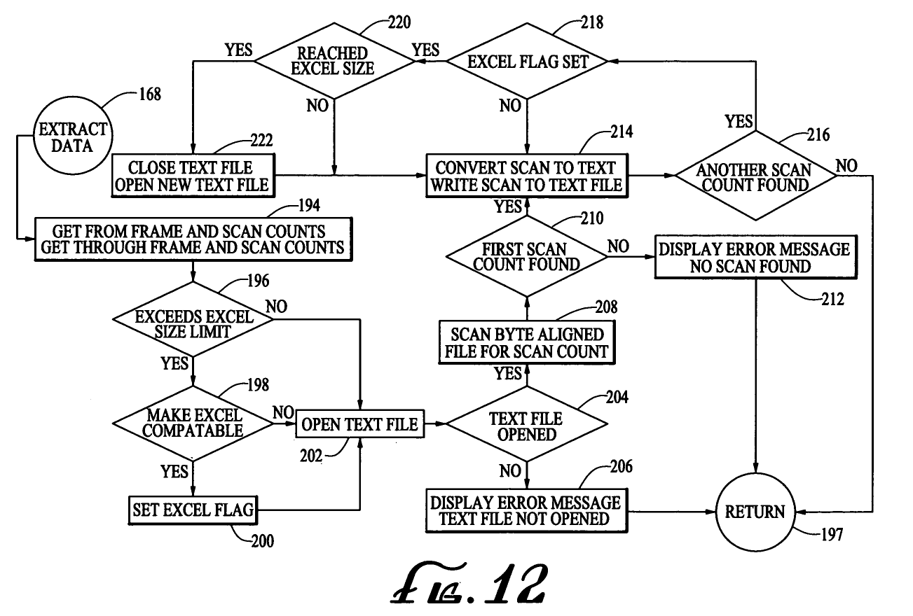

Referring to FIGS. 4, 10 and 11, program step 162 calls the Validate Extract Range routine of FIG. 11. This routine validates a user entered range specifying the range of binary data to be extracted from the binary decrypted file which is the aligned decrypted data file. Program step 170 gets the first frame and scan count and the last frame and scan count. This identifies the first scan contained in the aligned decrypted data file and the last scan contained in the aligned decrypted data file.

Program step 172 gets the from frame and scan count and the through frame and scan count. This identifies the range of radar scans from which the user wants to extract data. As shown in FIG. 4, by default, the user entered from and through range is identical to the range of radar scans contained in the decrypted binary data file.

Program step 174 is a decision block which determines if the user entered frame and scan counts fall within the range available in the decrypted file. Program step 174 tests to see if the From Frame is less than the First Frame of the file. If the From Frame is less than the First Frame, it is invalid and the program returns to the On Extract Button routine of FIG. 10 (program step 176). Program step 174 also tests to see if the From Frame is greater than the Last Frame of the file. If the From Frame is greater than the Last Frame, it is invalid and the program returns to the On Extract Button routine of FIG. 10.

Program step 178 determines if the From Frame is equal to the First Frame or the Last Frame of the file. If the From Frame is equal to the First Frame, the program checks to see if the From Scan is less than the First Scan (program step 180). If the From Scan is less than the First Scan, the program proceeds to program step 176, which indicates that the From Scan is outside the file range and is invalid. The program then returns to the On Extract Button routine of FIG. 10. If the From Frame is equal to the Last Frame, the From Scan is checked to see if the From Scan is greater than the Last Scan (program step 182). If it is the program proceeds to program step 176, which indicates that the From Scan is outside the file range and is invalid. If the From Scan is not greater than the Last Scan, the From Scan is a valid scan and is within the boundary of the range of data contained in the file.

The program proceeds to program step 184 to check the Through Frame entered by the user. Program step 184 first checks to see if the Through Frame is greater than the Last Frame contained in the file. If it is the program proceeds to program step 176, which indicates that the Through Frame is outside the file range and is invalid. Program step 184 also checks to see if the Through Frame is less than the From Frame. If it is the program proceeds to program step 176, which indicates that the Through Frame is invalid. If neither of these conditions exists, the Through Frame is a valid frame count.

Program step 186 checks to see if the Through Frame is equal to the Last Frame or the From Frame. If the Through Frame is equal to the From Frame, the program proceeds to program step 188. Program step 188 checks to see if the Through Scan is less than the From Scan. If the Through Scan is less than the From Scan, the program proceeds to program step 176, which indicates that the Through Scan is invalid. If the Through Scan is not less than the From Scan, the program proceeds to program step 190, which indicates that the Through Scan is within the file range and is valid.

If the Through Frame is equal to the Last Frame, the program proceeds to program step 192 to check the Through Scan. If the Through Scan is greater the Last Scan, the program proceeds to program step 176, which indicates that the Through Scan is outside the file range and is invalid. If the Through Scan is not greater then the Last Scan, the program again proceeds to program step 190, which indicates that the Through Scan is within the file range and is valid.

Finally, if the Through Frame is not equal to the From Frame or Last Frame, the program proceeds from program step 186 to program step 190 which indicates that the Through Frame is within the upper boundary of the range of data contained in the file.

Referring to FIGS. 4, 10 and 12, program step 168 calls the Extract Data routine. Program step 194 gets the From Frame and Scan Counts and the Through Frame and Scan Counts for the file which includes the binary data to be converted to ASCII text data. Program step 196 checks to see if the file to be extracted exceeds the Excel size limit. The Excel size limit is 16,777,216 data entries in a worksheet or spreadsheet, that is 65,563 data rows times 256 data columns, which equates to approximately 56 to 58 megabytes of radar video data.

Program step 198 checks to see if the user wants to make the extracted data or text file Microsoft Excel compatible. If the file is too large the file is broken up to chunks of data or smaller files which are compatible with Excel. If the user indicates that he wants to make the file Excel compatible an Excel Flag is set. The Excel Flag indicates the file must be Excel compatible. If the user indicates that the file does not have to be Excel compatible, the Excel Flag is not set and the program proceeds directly from program step 198 to program step 202. Program step 202 opens a text file, which is a “.txt” file in which the extracted and converted data is stored. Program step 204 checks to see if a text file is open and if a text file is not open, program step 206 displays an error message on monitor 24 “Text File Not Opened” and returns in program step 197 to the On Extract Button routine of FIG. 10.

If a text file is open, the program scans the byte align file for the scan count (program step 208). If the program is unable to find a valid scan count which indicates that a first scan was not located, an error message is displayed. Program step 212 displays the error message “No Scan Found”. If the program locates the first scan count, program step 214 converts the scan to ASCII text and writes the scan to a text file. The following example illustrates how each scan is written to the text file.

```
Frame,<frame count>
Scan,<scan count>
Video,Gate
<video sample>,<gate sample>
<video sample>,<gate sample>
  . . . . .
<video sample>,<gate sample>
  . . . . .
Frame,<frame count>
  . . . . .
```

The program next checks to see if another scan has been found (program step 216). If the answer is “No” the program proceeds to return (program step 197) and returns to the On Extract Button routine 160 of FIG. 10.

If the answer is “Yes”, the program checks to see if the Excel flag is set (program step 218). If the Excel Flag is not set, the next scan is converted to ASCII text and written to the text file. If the Excel Flag is set, a check is made to determine if the Excel size limit has been reached (program step 220). If the Excel size limit has not been reached, the program converts the scan to ASCII text and writes the scan to the text file currently open.

If the Excel size limit has been reached then the Text File is closed and a new text file is opened (program step 222). Each text file has imbedded in the last portion of the name the frame count and scan count range identifying the first and last radar scans contained in the file. For example, the text file identified in FIG. 4, TestFile1(292_{—}24-1073_{—}45).txt has a first frame count of 292, a first scan count of 24, a last frame count of 1073 and a last scan count of 45.

What is claimed is:

1. A method for decrypting radar video data recorded on a recorder comprising the steps of:
(a) transferring said radar video data from said recorder into an encrypted data file within a personal computer;
(b) opening said encrypted data file which includes said radar video data in an encrypted form interleaved with unencrypted recorder timing headers;
(c) specifying a header block range over which to decrypt said radar video data in said encrypted form, wherein a user specifies said header block range by entering a time range of said radar video data to be decrypted in a first block time text box and a last block time text box which appears on a monitor for said personal computer;
(d) engaging a decrypt button appearing on the monitor for said personal computer, wherein said user engages said decrypt button to invoke a decrypt function within a computer program on said personal computer;
(e) decrypting said radar video data within said time range from said encrypted form to an unencrypted binary form, wherein the decrypt function within said computer program directs and controls the decryption of said radar video data to said unencrypted binary form;
(f) opening a decrypted binary data file, wherein said decrypted binary data file includes said radar video data in said unencrypted binary form;
(g) specifying a range of scans for converting said radar video data contained in said decrypted binary data file to an ASCII form; and
(h) engaging an extract button appearing on the monitor of said personal computer, wherein said user engages said extract button to invoke an extract function within said computer program, said extract function within said computer program extracting said radar video data within said range of scans specified by said user from said decrypted binary data file and converting said radar video data from said unencrypted binary form to an ASCII form for storage in a text file.

2. The method of claim 1 further comprising the step of transferring said radar video data from said encrypted data file to a decryption unit which is connected to said personal computer, said decryption unit decrypting said radar video data and then transferring said radar video data to said personal computer.

3. The method of claim 2 wherein said personal computer includes a high speed interface board operating within said personal computer wherein said high speed interface board transfers said radar video data to said decryption unit at speeds of approximately 20 megabytes per second.

4. The method of claim 1 wherein said computer program byte aligns said radar video data after said radar video data from said encrypted data file is decrypted.

5. The method of claim 4 wherein said computer program aligns the radar video data using a frame sync offset within the radar video data as a reference for alignment and writes the radar video data to a byte aligned data file.

6. The method of claim 1 wherein said radar video data in said ASCII form is compatible with a spreadsheet computer program which allows said radar video data stored in said ASCII text file to be written to a spreadsheet having approximately 65,563 data rows by 256 data columns.

7. The method of claim 1 wherein said monitor displays a first frame count text box, a first scan count text box, a through frame count text box and a through scan count text box which allow said user to select and enter the range of scans of said radar video data for conversion by said computer program from said unencrypted binary form to said ASCII form for storage in said text file.

8. An apparatus for decrypting radar video data recorded on a recorder comprising:
(a) a personal computer for receiving said radar video data from said recorder and storing said radar video data in an encrypted form within an encrypted data file located in said personal computer for processing by said personal computer;
(b) a decryption device connected to said personal computer to receive said radar video data in said encrypted form from said personal computer, decrypt said radar video data, and transfer said radar video data to said personal computer in an unencrypted form.
(c) computer software contained within said personal computer, said computer software controlling handling and interpretation of said radar video data to and from said decryption device by said personal computer;
(d) a computer monitor connected to said personal computer, said computer monitor displaying a decrypt button which a user engages to transfer said radar video data from said personal computer to said decryption device for conversion to said unencrypted form;
(e) said computer software storing said radar video data in a decrypted binary data file within personal computer after said radar video data is decrypted by said decryption unit;
(f) said computer monitor displaying an extract button which said user engages to extract a range of scans of said radar video data from said decrypted binary data file for conversion to an ASCII comma delimited form;
(g) said computer software, responsive to said user engaging said extract button, extracting the range of scans of said radar video data from said decrypted binary data file; and
(h) said computer software converting said radar video data extracted from said decrypted binary data file to said ASCII comma delimited form.

9. The apparatus of claim 8 wherein said personal computer includes a high speed interface board operating within said personal computer wherein said high speed interface board transfers said radar video data to said decryption unit at speeds of approximately 20 megabytes per second.

10. The apparatus of claim 8 wherein said personal computer includes an ASCII text file for storing within said personal computer said radar video data in said ASCII comma delimited form.

11. The apparatus of claim 8 wherein said computer software byte aligns said radar video data after said radar video data from said encrypted data file is decrypted.

12. The apparatus of claim 12 wherein said computer software aligns the radar video data using a frame sync offset within the radar video data as a reference for alignment and writes said radar video data to a byte aligned data file.

13. The apparatus of claim 10 wherein said radar video data in said ASCII comma delimited form is compatible with a spreadsheet computer program which allows said radar video data stored in said ASCII text file to be written to a spreadsheet having approximately 65,563 data rows by 256 data columns.

14. An apparatus for decrypting radar video data recorded on a recorder comprising:
(a) a personal computer for receiving said radar video data from said recorder and storing said radar video data in an encrypted form within an encrypted data file located in said personal computer for processing by said personal computer;
(b) a decryption device connected to said personal computer to receive said radar video data in said encrypted form from personal computer, decrypt said radar video data and transfer said radar video data to said personal computer in an unencrypted form.
(c) computer software contained within said personal computer, said computer software controlling handling and interpretation of said radar video data to and from said decryption device by said personal computer;
(d) a computer monitor connected to said personal computer, said computer monitor displaying a decrypt button which a user engages to transfer said radar video data from said personal computer to said decryption device for conversion to said unencrypted form;
(e) said computer software storing said radar video data in a decrypted binary data file within said personal computer after said radar video data is decrypted by said decryption unit;
(f) said computer monitor displaying an extract button which said user engages to extract a range of scans of said radar video data from said decrypted binary data file for conversion to an ASCII comma delimited form;
(g) said computer software, responsive to said user engaging said decrypt button, extracting the range of scans of said radar video data from said decrypted binary data file;
(h) said computer software converting said radar video data extracted from said decrypted binary data file to said ASCII comma delimited form; and
(i) said computer monitor displaying a plurality of scan text boxes which allow said user to select and enter the range of scans of said radar video data for conversion by said computer software from said unencrypted binary form to said ASCII comma delimited form for storage in a text file within said personal computer.

15. The apparatus of claim 14 wherein said personal computer includes a high speed interface board operating within said personal computer wherein said high speed interface board transfers said radar video data to decryption unit at speeds of approximately 20 megabytes per second.

16. The apparatus of claim 14 wherein said computer software byte aligns said radar video data after said radar video data from said encrypted data file is decrypted.

17. The apparatus of claim 16 wherein said computer software aligns the radar video data using a frame sync offset within the radar video data as a reference for alignment and writes said radar video data to a byte aligned data file.

18. The apparatus of claim 8 wherein said radar video data in said ASCII comma delimited form is compatible with a spreadsheet computer program which allows said radar video data stored in said text file to be written to a spreadsheet having approximately 65,563 data rows by 256 data columns.

19. The apparatus of claim 14 wherein said plurality of scan text boxes include a first frame count text box, a first scan count text box, a through frame count text box and a through scan count text box.

20. The apparatus of claim 14 further comprising a pair of time block text boxes which are displayed on said monitor, said pair of time block text boxes allowing said user to select and enter a time range of said radar video data to be decrypted by said decryption unit and stored in said decrypted binary data file.
